(19) United States
(12) Patent Application Publication
(10) Pub. No.: US 2003/0138113 A1
(43) Pub. Date: Jul. 24, 2003

(54) Remote-controlled sound reproducing system of text data stored in a memory and control method therefor

(76) Inventor: Sang-Young Han, Seoul (KR)

Correspondence Address: BACON & THOMAS, PLLC, 625 SLATERS LANE, FOURTH FLOOR, ALEXANDRIA, VA, 22314

(21) Appl. No.: 10/239,855

(22) PCT Filed: Apr. 6, 2001
(86) PCT No.: PCT/KR01/00580

(30) Foreign Application Priority Data
Apr. 6, 2000 (KR) 2000/17927

(51) Int. Cl. H04B 3/00

(52) U.S. Cl. 381/77

(57) ABSTRACT

The present invention provides a remote-controlled sound reproducing system of text data stored in a memory, comprising a transmitter module for converting the text data stored in the memory into sound signals and for radio-transmitting the sound signals, and a receiver module for receiving the signals radio-transmitted from the transmitter module and for outputting sound corresponding thereto, whereby the text data stored in the memory is converted into the sound signals and radio-transmitted through the transmitter module to the receiver module and the sound signals received by the receiver module are converted into the sound to be outputted, so that a user located at a remote place can audibly confirm the contents of the texts displayed on a computer monitor. The present invention also provides a control method for a remote-controlled sound reproducing system of text data stored in a memory.

### TECHNICAL FIELD

The present invention relates to a system for converting text data recorded in a storage medium into sound, for allowing radio transmission of the sound signals and outputting the transmitted sound through a sound reproducing device located a short way off. More particularly, the present invention relates to a system for telling a user (e.g., child), who is located at a remote place, texts displayed on a computer monitor by synthesizing sound from text data stored in a computer, or information or a mail searched through the connection with the internet network and by modulating and outputting the sound through radio transmission, which in turn, is received and outputted by a receiver module (e.g., toy, etc.) having a receiving device and a sound reproducing device therein.

### BACKGROUND ART

Generally, text or sound data recorded in a storage medium (e.g., hard disk, ROM, RAM, CD-ROM, etc.) of a computer can be displayed or outputted through a display or output device.

The computer can be connected with the internet network, store information searched from various kinds of servers and provide a user with the stored information through a medium electrically connected with the computer.

Furthermore, the output device, which comprises an output medium to be mounted on the outside of the computer such as speakers or liquid crystal display, may be installed on a toy. Information can be provided through the output medium installed on the toy.

These methods may also be achieved by installing the output medium, which may be usually mounted within the computer, on the toy and electrically connecting the output medium to the computer.

With the advancement of technologies, a system capable of controlling a medium located at a remote place by using information stored in the computer has been developed and a variety of applied technologies related to the system have been proposed. As an example, a toy remote-controlled by information stored in the computer has been provided. The toy can be operated by radio output of the information stored in the computer.

The operated toy has been technically developed in that it can move or speak for itself by means of various kinds of control systems and mechanical systems installed on a body of the toy.

Such development of technologies has produced many applied technologies capable of controlling a toy by using a computer. For example, control data stored in the computer are radio-outputted and thus operate the toy located apart from the computer.

Practically, the data recorded in a storage medium that is installed on a body of the toy operate mechanical components of the toy so that the toy can move or speak. That is, the information recorded in the storage medium is expressed through the toy as the information radio-transmitted from the computer.

With the advancement of technologies, text data recorded in the storage medium of the computer can be displayed on a monitor and simultaneously outputted in the form of sound.

This technology development has produced a variety of applied technologies. Furthermore, there is a gradually growing tendency to develop the applied technologies using a computer and a toy.

However, in spite of the technology development, there is a problem in that, in case that a user wants to confirm text data stored in a storage medium of a computer, the user cannot know the contents of the text data until the user confirms them through a computer monitor or directly listens to the sound outputted from speakers mounted on the computer.

### DISCLOSURE OF INVENTION

The object of the present invention is to provide a remote-controlled sound reproducing system of text data stored in a memory, wherein text data displayed on a computer monitor are radio-transmitted through a transmitter module to a receiver module and the receiver module reproduce sound based on the received data, so that a user located at a remote place can confirm the text displayed on the monitor.

That is, a sound synthesizing program installed in the computer converts the text data into sound data and signals corresponding to the sound data are outputted by a sound output device (e.g., sound card). The outputted signals are modulated and radio-transmitted by the transmitter module. The radio-transmitted signals are demodulated by a receiving device and outputted in the form of sound by an output device.

In order to achieve the above object of the invention, the present invention provides a remote-controlled sound reproducing system of text data stored in a memory, comprising a transmitter module for converting text data displayed on a computer monitor into sound signals and for radio-transmitting the sound signals, and a receiver module for receiving the signals radio-transmitted from the transmitter module and for outputting sound corresponding thereto, whereby the text data stored in the memory are converted into the sound signals and radio-transmitted through the transmitter module to the receiver module, and the sound signals received by the receiver module are converted into the sound to be outputted, so that a user located at a remote place can audibly confirm the contents- of the text data stored in the memory.

In addition, the transmitter module may include a sound synthesizing program operated by control logic of a computer operating system program, for converting the text data stored in the memory into sound data; a sound card for outputting sound signals corresponding to the sound data converted by the sound synthesizing program; and a transmitting device connected with the sound card, for modulating and radio-transmitting the sound signals outputted from the sound card.

The transmitter module may include speaker connecting terminals and a volume adjusting switch so that the sound signals outputted from the sound card can be directly outputted through speakers.

That is, the terminals for connecting with external speakers, and the volume adjusting switch for adjusting the volume of the speakers connected through the terminals with the transmitter module are provided on a side of the transmitter module. Thus, the receiver module can output the sound through the speakers.

At this time, by providing a switch for controlling the transmitting operation of the transmitter module, it is possible to output the sound corresponding to the signals from the sound card through only the receiver module, through only the speakers connected with the transmitter module, or through both of them.

Further, the receiver module may include a receiving device for receiving the signals radio-transmitted from the transmitter module and for separating sound signals from the transmitted signals, and an output device for outputting the sound corresponding to the sound signals separated by the receiving device.

The output device may include an amplifier for amplifying the sound signals and speakers for outputting the sound corresponding to the signals from the amplifier.

On the other hand, according to another aspect of the present invention, there is provided a control method for a remote-controlled sound reproducing system of text data stored in a memory. The system comprises a transmitter module for converting text data stored in the memory into sound signals and for radio-transmitting the sound signals, and a receiver module for receiving the signals radio-transmitted from the transmitter module and for outputting sound corresponding thereto. The method of the present invention comprises a sound conversion step of continuously detecting whether a user gives a control command to convert the text data into sound and output the sound, and of converting pertinent characters or texts into sound data by executing a sound synthesizing program when there is the control command to output texts in the form of sound; a radio transmission step of outputting, through a sound card, sound signals corresponding to the sound data converted and inputted from the sound conversion step, and of radio-transmitting the sound signals; a receiving step of receiving, by a receiving device, the signals radio-transmitted through the radio transmission step, and of separating sound signals therefrom; and an output step of outputting, through speakers, the sound corresponding to the sound signals separated through the receiving step; whereby the text data stored in the memory is converted into the sound signals by the execution of the sound conversion step and radio-transmitted to the receiver module by the execution of the radio transmission step, and the radio-transmitted sound signals are received and outputted through the speakers by the execution of the receiving and outputting steps.

According to the remote-controlled sound reproducing system of text data stored in a memory and the control method therefor of the present invention constructed as such, the texts displayed on a computer monitor are converted into the sound signals and radio-transmitted to the receiver module located at a remote place where the sound signals are outputted in the form of sound, so that the user can know the texts displayed on the monitor even though the user is not in the vicinity of the computer.

### BRIEF DESCRIPTION OF DRAWINGS

FIG. 1 is a block diagram showing the constitution of a remote-controlled sound reproducing system of text data stored in a memory, according to the present invention.

FIG. 2 is a constitutional view of an embodiment of the remote-controlled sound reproducing system of text data stored in the memory, according to the present invention.

FIG. 3 is a control flowchart showing a control method for the remote-controlled sound reproducing system of text data stored in the memory, according to the present invention.

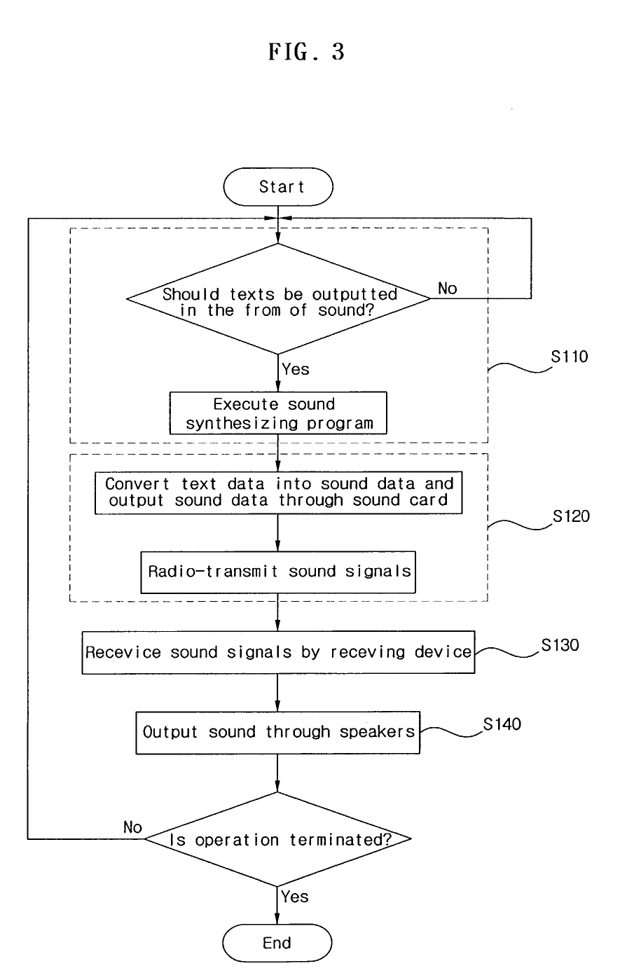

### BEST MODE FOR CARRYING OUT THE INVENTION

Hereinafter, a preferred embodiment of a remote-controlled sound reproducing system of text data stored in a memory and a control method therefor according to the present invention will be explained in detail.

This embodiment exemplifies a toy with a receiver module mounted therein.

Therefore, the toy contains a receiving device and an output device therein.

In addition, this embodiment exemplifies a transmitter module having, on one side thereof, connecting terminals for connecting with speakers, a volume adjusting switch, and an output adjusting switch.

At this time, by means of the output adjusting switch, it is possible to output sound corresponding to signals converted from texts through only speakers connected with the transmitter module, through only speakers connected with a receiving module or through both of them.

Hereinafter, the constitution of the embodiment will be described in detail with reference to the accompanying drawings.

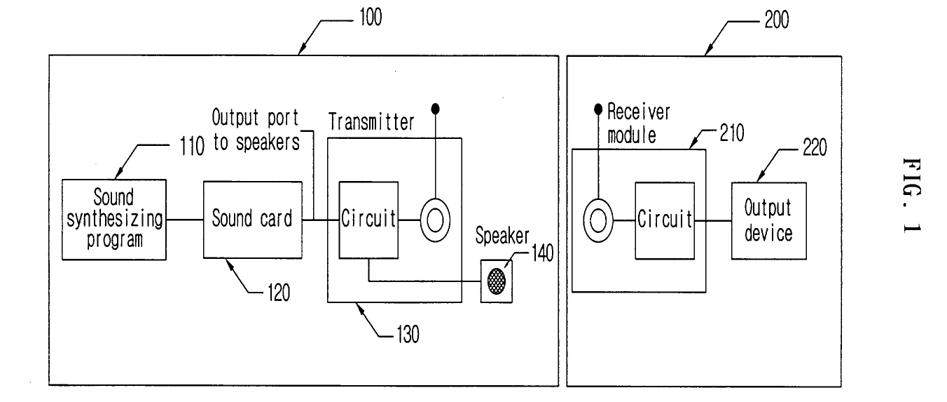

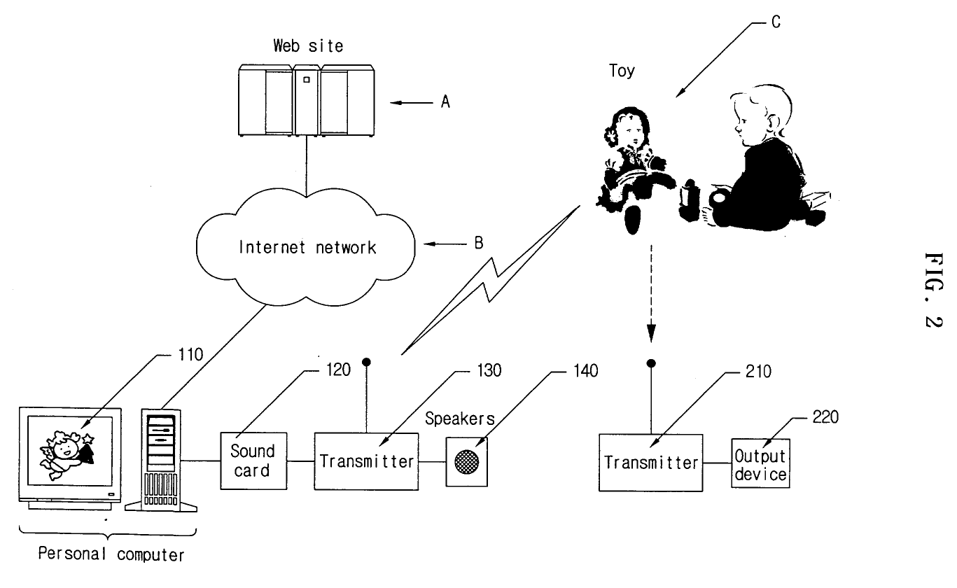

First, as shown in FIGS. 1 and 2, when a user gives a control command to execute a sound synthesizing program 110 installed in a computer, characters or texts selected by the user, or texts displayed on a computer monitor or stored in a memory (e.g., buffer) are converted into sound to be outputted.

Further, after a sound card 120 is mounted in the computer, an output terminal of the sound card is connected with a connecting terminal of a transmitting device 130 and external speakers are connected with external speaker connecting terminals of the transmitting device, thereby constructing a transmitter module 100 according to the embodiment of the present invention.

On the other hand, after the transmitter module 100 is constructed as such, a receiving device 210 and an output device 220 are contained in a toy C to construct a receiver module 200 according to the embodiment of the present invention.

At this time, the output device 220 consists of an amplifier for amplifying sound signals outputted from the receiving device 210 and speakers for outputting sound corresponding to the amplified signals.

Moreover, in the case that the transmitting device 130 of the transmitter module 100 and the receiving device 210 of the receiver module 200 transmit and receive the signals, respectively, an identification (ID) code may be assigned specific transmitting and receiving devices so that signals outputted from the specific transmitting device can be received only by the specific receiving device having the same ID code as the transmitting device.

Hereinafter, the operation of this embodiment constructed as such will be described in detail with reference to the accompanying drawings.

The operation will be described as to the case that a juvenile story is converted into sound that in turn, is told a user (children) through a toy carried by the user.

First, by the process of sound conversion step S110, when texts (juvenile story) stored in a storage medium (hard disk, CD-ROM, etc.) or obtained through the internet network are displayed on the monitor, the transmitting module 100 continuously detects whether the user gives a control command to convert the texts into sound and output the sound, and the pertinent characters or texts are converted into sound data by executing a sound synthesizing program 110 when there is the control command to output the texts in the form of sound.

That is, when the user defines the range to be converted into sound among the texts displayed on the monitor and selects a sound output menu, the sound corresponding to the defined texts is synthesized and outputted by the execution of the sound synthesizing program 110.

Then, by the process of radio transmission step S120, sound signals outputted through the sound card 120 are modulated and assigned an identification (ID) code, which in turn are radio-transmitted through the transmitting device 130 to the receiver module 200.

On the other hand, by the process of receiving step S130, the receiver module 200 continuously detects whether signals having the identification code identical with that of the receiver module are received, and when there are signals transmitted to itself, the receiving device 210 receives the sound signals to be outputted. Thereafter, the received sound signals are amplified and outputted by the process of output step S140.

That is, when the user defines the range to be outputted in the form of sound, such as the entire portion or a portion of the juvenile story displayed on the monitor, and selects the sound output menu, the defined range is radio-transmitted through the transmitter and receiver modules 100 and 200 to the toy to be outputted in the form of sound. Thus, the user located at a remote place audibly recognizes the contents of the texts displayed on the computer monitor.

For example, by using the computer, a mother can tell the juvenile story to her children through the toy located at a remote place.

Although the contents to be converted into sound has been limited to the juvenile story in the above embodiment, it should be understood that all kinds of documents which can be controlled by a computer and obtained through the internet network can be converted into sound.

It should also be understood that most of the languages including the Korean language can be converted.

Further, although the output device of the receiver module has been limited to the speakers in the above embodiment, it should be understood that the technical spirit of the present invention is not limited thereto.

Furthermore, although the receiver module has been contained in the toy in the above embodiment, it should be understood that the technical spirit of the present invention is not limited thereto.

### INDUSTRIAL APPLICABILITY

As described with reference to the embodiment, according to the remote-controlled sound reproducing system of text data stored in the memory and the control method of the present invention, there is an advantage that texts stored in the memory for the computer or text information searched through the internet network can be converted into sound and then outputted through the receiver module located apart from the computer, so that the contents of the texts displayed on the monitor can be confirmed even at a remote place.

1. A remote-controlled sound reproducing system of text data stored in a memory, comprising:
said memory with said text data stored therein;
a transmitter module for reading said text data, converting said text data into sound signals and radio-transmitting said sound signals; and
a receiver module for receiving said signals radio-transmitted from said transmitter module and for reproducing sound corresponding thereto.

2. The remote-controlled sound reproducing system as claimed in claim 1, wherein said transmitter module includes a sound synthesizing program operated by control logic of a computer operating system program, for converting said text data stored in said memory into sound data; a sound card for outputting sound signals corresponding to said sound data converted by said sound synthesizing program; and a transmitting device connected with said sound card, for modulating and radio-transmitting said sound signals outputted from said sound card.

3. The remote-controlled sound reproducing system as claimed in claim 1, wherein said transmitter module includes speaker connecting terminals and a volume adjusting switch so that said sound signals outputted from said sound card can be directly outputted through said speakers.

4. The remote-controlled sound reproducing system as claimed in claim 1, wherein said receiver module includes a receiving device for receiving said signals radio-transmitted from said transmitter module and for separating sound signals from said transmitted signals, and an output device for outputting said sound corresponding to said sound signals separated by said receiving device.

5. A control method for a remote-controlled sound reproducing system of text data stored in a memory including a transmitter module for converting said text data stored in said memory into sound signals and for radio-transmitting said sound signals, and a receiver module for receiving said signals radio-transmitted from said transmitter module and for outputting sound corresponding thereto, comprising:
a sound conversion step of continuously detecting whether a user gives a control command to convert said text data into sound and output said sound, and of converting pertinent characters or texts into sound data by executing a sound synthesizing program when there is said control command to output said texts in the form of sound;
a radio transmission step of outputting, through a sound card, sound signals corresponding to said sound data converted and outputted from said sound conversion step, and of radio-transmitting said sound signals;
a receiving step of receiving, by a receiving device, said signals radio-transmitted through said radio transmission step, and of separating sound signals therefrom; and
an output step of outputting, through speakers, said sound corresponding to said sound signals separated through said receiving step.
